(19) United States
(12) Patent Application Publication
(10) Pub. No.: US 2015/0035987 A1
(43) Pub. Date: Feb. 5, 2015

(54) METHOD AND APPARATUS FOR UNLOCKING/LOCKING A DOOR AND ENABLING TWO-WAY COMMUNICATIONS WITH A DOOR SECURITY SYSTEM VIA A SMART PHONE

(71) Applicant: Jose Mario Fernandez, Santa Ana, CA (US)

(72) Inventor: Jose Mario Fernandez, Santa Ana, CA (US)

(21) Appl. No.: 14/516,060

(22) Filed: Oct. 16, 2014

Related U.S. Application Data
(63) Continuation-in-part of application No. 13/606,690, filed on Sep. 7, 2012.

(51) Int. Cl. H04N 7/18

(52) U.S. Cl. CPC H04N 7/186
USPC 348/156

(57) ABSTRACT

A method and computer program product for operating a doorbell security system. The method may include receiving a doorbell press event signal and sending a doorbell press event notification to at least one mobile computing device. The method may further include opening a video channel connection and an open but disabled audio channel to the mobile computing device. The end user may view a visitor at the door of the doorbell security system before determining whether to enable the audio channel.

### CROSS REFERENCE TO RELATED APPLICATIONS

This continuation in part application claims priority to non-provisional U.S. patent application Ser. No. 13/606,690 filed on Sep. 7, 2012, the entire contents of which is herein incorporated by reference.

### FIELD OF THE INVENTION

The present invention is directed generally toward a system and method of enabling a user to receive doorbell notifications, communicate with a visitor, and unlock a door via a mobile computing device.

### BACKGROUND OF THE INVENTION

Currently, doorbell security systems have limited audio and video capabilities. Doorbell security systems allow a user/resident to determine who is at the door without physically going to the door. Current doorbell security systems are usually implemented as a local system of a residence such that a user may only view or hear a guest at the door if the user is located in front of a video phone device located on the premises. Current doorbell security systems further lack the capability to handle real-time two-way audio and one-way video between a visitor and a user of a mobile device over mobile phone networks. Additionally, significant unresolved latency problems exist for communicating real-time two-way audio and one-way video between a doorbell intercom and a mobile computing device.

Therefore, it may be desirable to provide a method and apparatus which address the above-referenced problems.

### SUMMARY OF THE INVENTION

Accordingly, a system is included for doorbell security system for providing a client user surveillance and communication with a visitor at a door. The system comprises: a doorbell configured to provide a triggered doorbell signal event; a video camera coupled to the doorbell and configured to capture video of the visitor at the door, wherein the video camera establishes a live video feed transmitted to a mobile computing device via a SIP or VoIP connection in response to the doorbell signal event being triggered; and an intercom coupled to the doorbell, the intercom configured to maintain an audio channel disabled during the live video feed until the client user activates the audio channel for communication with the visitor.

A computer program product embodiment on a mobile computing device for alerting an end client user of a visitor at a door and providing an option to communicate with the visitor comprises a non-transitory computer readable storage medium having computer readable program code. The computer readable program code may be configured to: receive a triggered doorbell signal event signal; open a live video feed of the visitor at the door transmitted to the mobile computing device via a SIP or VoIP connection in response to the doorbell signal event being triggered; and open a disabled audio channel of an intercom at the door, with the mobile computing device via the SIP or VoIP connection in response to the doorbell signal event being triggered.

It is to be understood that both the foregoing general description and the following detailed description are exemplary and explanatory only and are not restrictive of the invention claimed. The accompanying drawings, which are incorporated in and constitute a part of the specification, illustrate embodiments of the invention and together with the general description, serve to explain the principles.

### BRIEF DESCRIPTION OF THE DRAWINGS

The numerous objects and advantages of the present invention may be better understood by those skilled in the art by reference to the accompanying figures in which:

FIG. 1 shows a diagram of an audio/video door phone system;

FIG. 2 shows a diagram of a doorbell security system;

FIG. 3 shows a suitable system architecture diagram associated with embodiments of the doorbell security system;

FIG. 4 shows a block diagram of a suitable configuration of electronic components of a doorbell security system board;

FIG. 5 shows a block diagram of suitable firmware architecture associated with the doorbell security system and a server;

FIG. 6 shows a diagrammatic view of a screen displaying a doorbell notification;

FIG. 7 shows a diagrammatic view of a door security system application running on a smartphone screen;

FIG. 8 shows a suitable software architecture diagram of an embodiment configured to support iOS 4;

FIG. 9 shows a suitable software architecture diagram of an embodiment configured to support iOS 3;

FIG. 10 shows a suitable software architecture diagram of an embodiment configured to support Android;

FIG. 11 shows a suitable software architecture diagram of an embodiment configured to support third party devices;

FIG. 12 shows a diagram of a notification system for an iPhone 3 platform;

FIG. 13 shows a diagram of a device communicating 1500 with an APNS server;

FIG. 14 shows a further diagram of a device communicating 1500 with an APNS server;

FIG. 15 shows an additional diagram of a device communicating 1500 with an APNS server;

FIG. 16 shows a diagram of a secured token communication;

FIG. 17 shows an embodied method for operating a doorbell security system;

FIG. 18 is a flowchart of a method for operating a doorbell security system in accordance with an embodiment of the subject technology; and

FIG. 19 is a block diagram of a computer system/server according to an embodiment of the subject technology.

### DETAILED DESCRIPTION OF THE INVENTION

Embodiments of the invention may include a doorbell security system configured to send a user doorbell notifications on a mobile computing device (such as a smartphone (e.g., an iPhone, Android-based phone, or the like), a tablet computing device (e.g., an iPad, Android-based tablet, or the like), or the like) or personal or desktop computer which may be connected to the internet. The doorbell security system can be configured to establish communication between a guest at a door and a user of a mobile computing device with two-way audio and one-way/two-way video. The doorbell security system can be configured to unlock or lock the door by sending a signal to activate a relay configured to activate or power an unlock/lock mechanism (such as an electrical or motorized unlock/lock mechanism). The doorbell security system can be configured to open or close a door by sending a signal to activate a relay configured to activate or power a door opener/closer mechanism (such as an electrical or motorized door opener/closer mechanism). The doorbell security system may allow the user to receive doorbell call events, establish audio/video communication with the visitor, and control door entry by activating or deactivating relays, relay contacts, contactors, or the like.

Embodiments of the invention may include a doorbell security system, a door lock application configured to run on a mobile computing device (such as a smart phone), a method, and a device. A doorbell security system may allow the user to control door operation remotely. The doorbell security system product can replace an existing door lock entry system, whereby the existing door lock entry system requires operation from inside the home. Implementations of the invention can use existing analog video, analog audio lines, cameras, analog audio speakers, or other equipment.

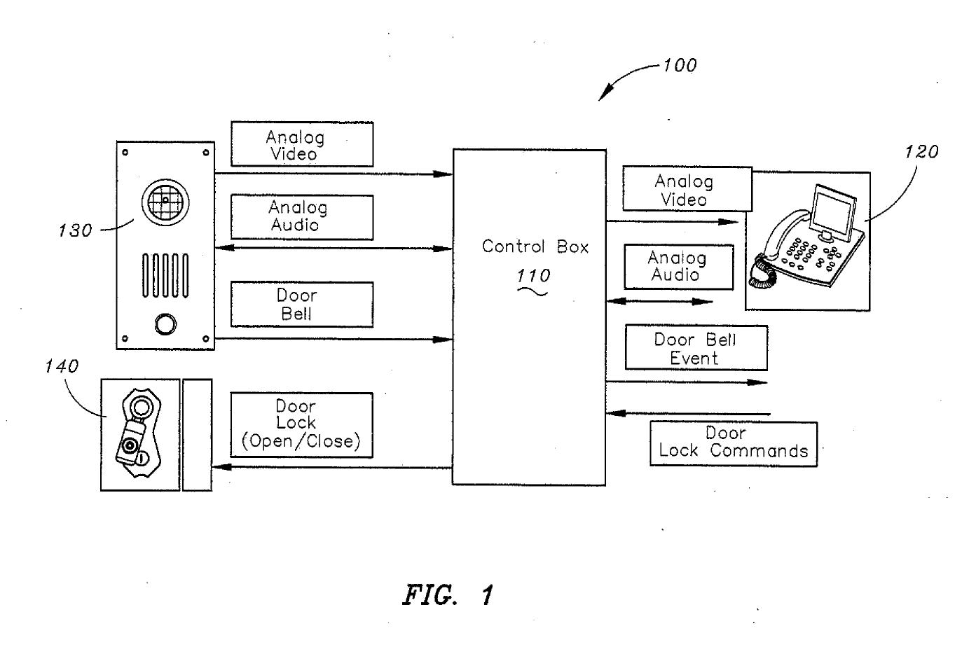

Referring to FIG. 1, a diagram of an audio/video door phone system 100 (such as a Holovision door phone system) is depicted. The video door phone may process doorbell events (such as a visitor pressing the doorbell) and alert the home owner through an audio ring of the doorbell event. When the home owner responds to the ring (e.g., by pressing a button on the video phone or by picking up the handset of a video phone), a session may be established with the visitor. The home owner may communicate with visitor through audio and may view video of the visitor. After verifying authenticity of the visitor, the home owner may issue a door open or unlock command from the device, whereby the command, for example, is configured to unlock or open the door.

The audio/video door phone system may include a control box 110, one or more video phones 120, one or more doorbells 130, one or more relays, and one or more door locks 140.

The control box 110 may include a processor, memory, storage, one or more controllers (such as an audio controller, a video controller, or the like), wireless transmitter/receiver, other computer hardware, software, firmware, or the like. The control box 110 may be communicatively coupled to the one or more video phones 120, the one or more doorbells 130, the one or more relays, and the one or more door locks 140.

Each doorbell 130 may comprise an audio/video intercom doorbell. An audio/video intercom doorbell can include a camera, a microphone, a speaker, and one or more doorbell user interfaces (such as a button, a touchscreen, or the like). Each doorbell 130 may be communicatively coupled to the control box 110.

Each video phone 120 may be configured to allow communication between a user of the video phone 120 and a visitor at the audio/video intercom doorbell. The video phone 120 may further include a display configured for viewing video captured by the camera of the audio/video intercom doorbell, a speaker for playing audio captured by the microphone of the audio/video intercom doorbell, and a microphone configured to capture or record audio from a user of the video phone

120.

Each door or door lock 140 can be configured such that the control box (in response to a signal or command received from the video phone) can open or close the door by sending a signal to activate a relay configured to activate or power a door opener/closer mechanism (such as an electrical or motorized door opener/closer mechanism). Each door or door lock 140 can further be configured such that the control box (in response to a signal or command received from the video phone) can unlock or lock the door by sending a signal to activate a relay configured to activate or power an unlock/lock mechanism (such as an electrical or motorized unlock/lock mechanism).

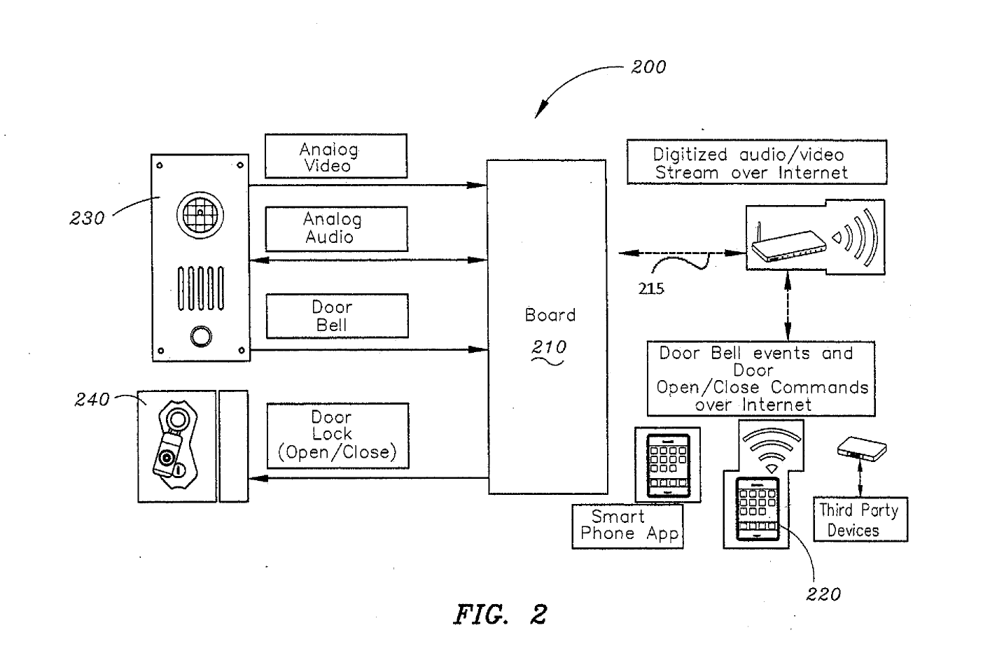

Referring to FIG. 2, a diagram of an embodiment of a doorbell security system 200 is depicted. Some embodiments of the doorbell security system 200 may include a product, device, control box, or board 210 configured to allow a user to unlock, lock, open, or close a door or door lock 240 remotely from an application hosted on a mobile computing device platform 220 (such as a smartphone or tablet computing device). The product, device, control box, or board 210 may process the doorbell button press event received from a doorbell 230 and connect the visitor to a registered smart phone/mobile computing device user (e.g., the home owner) over an internet/Ethernet link, upon the occurrence of the event.

The doorbell security system 200 may include a product, device, control box, or board 210; one or more network connections 215; one or more mobile computing devices 220 (such as one or more smart phones, tablet computing devices, or the like); one or more doorbells 230; one or more relays; one or more doors or door locks 240; one or more components of a particular audio/video door phone system 100; or the like.

The product, device, control box, or board 210 may include a processor, memory, storage, one or more controllers (such as an audio controller, a video controller, or the like), wireless transmitter/receiver, one or more storage mediums (such as one or more hard drives, solid state drives), one or more removable storage mediums (such as one or more removable flash cards or the like), memory (such as RAM (random access memory) or the like), one or more data ports, one or more user-interfaces (such as buttons or the like), one or more batteries, one or more power ports, other computer hardware, software, firmware, or the like. The product, device, control box, or board 210 may be communicatively coupled to the one or more mobile computing devices 220 through a hardwired or wireless network connection 215, one or more doorbells 230, one or more relays, one or more doors or door locks 240, one or more components of a particular audio/video door phone system 100, or the like.

Each doorbell 230 may comprise an audio/video intercom doorbell. An audio/video intercom doorbell can include a camera, a microphone, a speaker, and one or more doorbell user interfaces (such as a button, a touchscreen, or the like). Each audio/video intercom doorbell may be configured to send and/or receive analog or digital audio or video signals or streams (for example, SIP or VoIP based data as described below) through the network connection(s) 215. Each doorbell 230 may be communicatively coupled to the product, device, control box, or board 210.

The one or more mobile computing devices 220 may include one or more smart phones, tablet computing devices, or the like. Each mobile computing device may be configured to communicate with the product, device, control box, or board 210 such that a user of the mobile computing device 220 can communicate with or receive audio and/or video of a visitor in proximity to a particular doorbell 230. Each mobile computing device 220 may be configured to receive real-time audio and/or real-time video from the particular doorbell 230 and send real-time audio and/or video to the particular doorbell 230. Each mobile computing device 220 may be configured to receive doorbell event notifications, such as a notification that a doorbell 230 has been pressed. Each mobile computing device 220 may further be configured to send commands (such as commands to unlock, lock, open, or close a door, to ignore the doorbell or visitor, to activate or deactivate the door security system 200, to enable or disable particular mobile computing devices from accessing or interacting with the doorbell security system 200, or the like) to the product, device, control box, or board 210. Each mobile computing device 230 may include an application running on the mobile computing device 230 configured for executing code to perform functions described herein.

Each mobile computing device 220 may be configured to communicate wirelessly via a wireless network or communicate with wires via a wired network. Each mobile computing device 220 may include a display (such as an LCD (liquid crystal display) display or LCD touch-screen display), one or more cameras, one or more microphones, one or more speakers, one or more processors, one or more transmitter/receivers, one or more storage mediums (such as one or more hard drives, solid state drives), one or more removable storage mediums (such as one or more removable flash cards or the like), memory (such as RAM (random access memory) or the like), one or more data ports, one or more user-interfaces (such as buttons or the like), one or more batteries, one or more power ports, other computer hardware, software, firmware, or the like.

Each door or door lock 240 can be configured such that the product, device, control box, or board 210 (in response to a signal or command received from a particular mobile computing device) can open or close the door by sending a signal to activate a relay configured to activate or power a door opener/closer mechanism (such as an electrical or motorized door opener/closer mechanism). Each door or door lock 240 can further be configured such that the product, device, control box, or board 210 (in response to a signal or command received from a particular mobile computing device) can unlock or lock the door by sending a signal to activate a relay configured to activate or power an unlock/lock mechanism (such as an electrical or motorized unlock/lock mechanism).

The product, device, control box, or board 210 may utilize existing analog audio and/or video, and then digitize and compress the analog audio and/or video (using standard encoders/decoders) and transmit the digitized and/or compressed audio and video over a network connection such as a TCP/IP (Internet) link. The doorbell security system 200 can establish or enable real-time or substantially real-time bi-directional audio communication between the visitor at the doorbell 230 and the user of the mobile computing device 230 (such as a smart phone). In some implementations, the doorbell security system 200 may allow only uni-directional video communication from in front of the doorbell 230 to the recipient mobile computing device 220.

The product, device, control box, or board 210 can also handle action commands (Open Door/Close Door) received from a user of a mobile computing device 220 (such as smart phone). In response to receipt of a particular action command, the product, device, control box, or board 210 may, for example, perform door lock/unlock operations using electromechanical or mechanical relays (such as NC/NO (“normally closed/normally open”) relays or the like).

One doorbell unit 230 can be configured to connect to multiple recipient mobile computing devices 230 via the product, device, control box, or board 210 and network connection(s) 215); however, in some implementations, only one recipient mobile computing device 220 will be permitted to communicate with doorbell 230 at any point in time. That is, one smart phone/device application may connect to multiple doorbell systems (such as a front door system and back door system) but may be configured to control only one door at a time.

All communications from the application of the mobile computing device 220 to the product, device, control box, or board 210 may be secured. Mobile computing devices 220 may be paired with the doorbell security system 200. Pairing of devices (doorbell unit and the allowed recipient mobile computing devices 220) may require authorization of applications running on mobile computing device platforms (such as smart phone platforms).

The doorbell unit 230 may be powered by Wired Ethernet (PoE) or 12 V DC regulated DC input. The user may have an option to choose which voltage source to use. The doorbell security system board 210 may be installed along with the doorbell unit such that the doorbell unit 230 is communicatively coupled with the doorbell security system board 210.

An application may be loaded or installed onto one or more mobile computing devices 220. The application may be configured to run on various mobile computing devices 220. For example, the application may be supported on Apple's most up to date iPhone iOS and iPad iOS as well as devices running Google's Android operating system. Main parts of the operation of the system may include: the doorbell press event; one-way video transmission from the product, device, control box, or board 210 to the application of the mobile computing device 220; bi-directional audio communication; and transmission of the door lock/unlock command from the application of the mobile computing device 220 to the product, device, control box, or board 210.

The doorbell security system board 210 may be responsible for transmitting the doorbell press events to the associated mobile computing devices 220 such that the user is alerted or notified of the doorbell press events. The particular mobile computing device 220 or the application may be configured such that the user can choose to respond to the alert. Response to the alert can automatically invoke the application. Additionally, the user may choose to ignore the alert, wherein the application is not invoked.

Once the application is invoked, the user may be able to view the video (H.264, MJPEG) being captured by the camera installed with the doorbell unit in real-time or substantially real-time.

An audio channel may be established between the doorbell security system board 210 and the application facilitating two-way voice communication between the visitor at the door and the user of the mobile computing device 220. Suitable audio formats (e.g., 16-bit PCM, GSM-AMR, MC, G.711) available on all platforms may be used.

At any point during the conversation or when the application is running, the user of the mobile computing device 220 may have access to one or more actions or commands. For example, the user may be prompted to lock the door, unlock the door, or ignore the doorbell press event, or exit. These actions may be executed, for example, by clicking or pressing a button associated with the application on the screen of the mobile computing device 220. These actions or commands may be transmitted to the product, device, control box, or board 210 via a secure or unsecured channel, wherein, for example, the action(s) or command(s) are configured to lock or unlock the door using electromechanical or mechanical relays. Additional actions may include muting or disabling a microphone of the mobile computing device 220, muting or disabling a camera of the mobile computing device 220, or the like.

Embodiments of the invention may include or utilize electronics, software, firmware, applications of mobile computing devices 220, or the like.

A doorbell security system board 210 may be configured to handle digital and/or analog audio output from a microphone, analog and/or digital video output (such as NTSC/PAL composite video—RF modulated) from a camera, and a doorbell press signal (TTL voltage) from the doorbell. A doorbell security system board 210 may be configured for providing analog audio input to at least one speaker and may configured to generate lock/unlock door signals (through relay contacts). A doorbell security system board 210 can use suitable hardware configured to support generation of suitable video formats, such as H.264 and MJPEG. Suitable hardware may be configured to support additional video formats. The doorbell security system may be configured to minimize overall communication latency. Furthermore, overall communication latency from the doorbell security system board may be configured not to exceed a selected duration (e.g., 0.05 seconds, 0.5 seconds, 2 seconds, 10 seconds, or 30 seconds). The doorbell security system board 210 may be powered, for example, by Power on Ethernet (PoE) or 12V regulated DC.

Firmware or software of the doorbell security system 200 may be configured to provide a software API interface over TCP/IP link for third party products or applications to interface with the door lock or door unlock/lock mechanism. An exemplary application may include software running on iPhone/iPad/Android platform connected to doorbell security system 200 via the internet. The firmware or software may include a mobile computing device 220 application configured to transmit data over the internet link whenever the doorbell is pressed. Firmware or software may be configured for digitized video streams to be encoded according to suitable video compression standards, such as H.264, MJPEG, MJPEG-2, or the like. Firmware or software may be configured for digitized audio streams to be encoded as per standard file formats, such as AAC, 16 bit PCM or GSM-AMR. Firmware or software may be configured to use analog audio and/or video output generated by an existing system, and then, digitize and encode multi-media data and stream the data over internet link. The firmware or software may be configured to receive audio from a mobile computing device application connected over the internet link and configured to process the audio. Firmware or software may be configured to receive commands (such as lock or unlock door commands) from a mobile computing device application connected over internet link. Firmware or software may be configured for notification and command control communication to be via a secured channel (such as SSL/TSL). Firmware or software may be configured for storing some or all video/audio communications such as for audit trail or log purposes. Firmware, software, and/or hardware may further support audio amplification of one or more signals. Hardware, software, and/or firmware may be configured to include a communication protocol configured to suppress ECHO. Firmware and/or software may be configured with one or more options to zoom, pan, tilt, or otherwise adjust a camera. Firmware and/or software may support storage of audio and/or video logs on associated platforms or storage associated with associated platforms.

One or more mobile computing device applications may be configured to interface with the doorbell security system 200. An application of the mobile computing device may use suitable or otherwise standard communication protocols such as HTTP, RTP/RTSP, UDP/IP, and/or TCP/IP over an internet link. The application may be configured for bi-directional audio communication between a mobile computing device user and the visitor. In some implementations, the application may permit only uni-directional video communication between the mobile computing device user and the visitor such that the mobile computing device user may view video of the visitor but the visitor cannot view video of the mobile computing device user. The application may be configured to process digitized video/audio stream sent from the doorbell security system 200 and display/play the same on the mobile computing device 220 screen. The application may also send digitized audio stream from the mobile computing device 220 to the visitor at the doorbell 230. The application may be configured with action or command buttons configured to perform actions on the doorbell security system 200. For example, an enable doorbell security system action button may be configured to enable the doorbell security system 200. The application may be supported on versions of mobile computing devices such as iPhones or iPads (Apple iOS) (e.g., versions of iOS3, 4 or 5, or later) and/or Google Android OS platforms (e.g., versions 2 or later), other operating systems, or similar platforms. The application may be protected with a password. The application may include registering/unregistering mechanisms with the doorbell security system board 210. The application may further include an option to mute audio output/input. The application may support storage of audio/video logs on associated platforms or storage associated with associated platforms.

The doorbell security system 200 or doorbell of the system 200 may include an integrated camera which may be configured for advanced control of video images.

Some embodiments of the doorbell security system may be configured such that only one mobile computing device 220 has an active connection with an associated doorbell unit at any point in time. In some implementations, some embodiments of the doorbell security system may be configured to allow multiple mobile computing devices to have an active connection with an associated doorbell unit at a point in time.

Some embodiments of the doorbell security system may be configured such that a doorbell press event is transmitted to multiple associated or registered mobile computing devices 220, wherein only a first device to respond can establish a connection with the doorbell security system 200. Other mobile computing devices may be blocked from connecting to the doorbell security system 200.

Some embodiments of the doorbell security system 200 may be configured such that a mobile computing device user may not be able to hand over or pass an established connection to another mobile computing device user.

Some embodiments of the doorbell security system 200 may be configured such that if a registered mobile computing device 220 is powered off or lacks network connectivity when an when a doorbell press event is transmitted, the failure of the mobile computing device 220 to receive the transmitted doorbell press event will be handled as a “no response.” The doorbell security system 200 may be configured such that if doorbell press events are raised simultaneously from multiple doorbell units 230 associated with the same registered mobile computing device, a particular doorbell press event of a particular doorbell 230 will take precedence and the other(s) may be ignored. The doorbell security system 200 may be configured to handle multiple doorbell press events from the same doorbell unit 230 within a predefined time range (for example, 2 seconds, 10 seconds, 30 seconds, 1 minute, or the like) as a single doorbell press event. The doorbell security system 200 may be further configured to ignore doorbell press events after a connection is established.

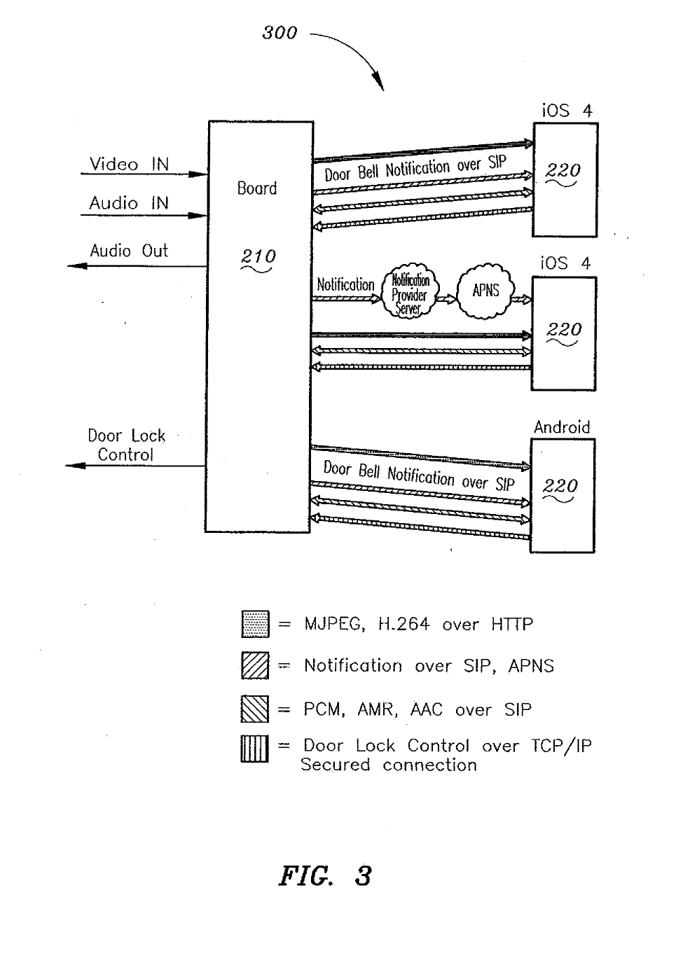

Referring to FIG. 3, a suitable system architecture 300 diagram associated with embodiments of the doorbell security system 200 is depicted. The overall architecture of a system is depicted in the figure above. Technical architecture may differ based on multi-tasking support available on various smartphone or mobile computing device platforms.

The doorbell security system 200 and/or application may be configured to run on mobile computing device platforms which support multitasking applications (such as iOS4/iPhone4, Android, or the like).

On mobile computing device platforms which support multitasking applications, at a time of application start-up, the application may initiate an audio session with the doorbell security system board 210 over an IP (internet protocol) link using SIP (Session Initiation Protocol) protocol. The application may run in background mode thus permitting a user to work on other applications. The board 210 may use this connection to send doorbell notifications since the protocol may allow bi-directional communication. The background application/OS (operating system) may listen on a VOIP (Voice Over IP) socket, and arrival of data packets on this socket may notify the user of the event. If the user acknowledges the event, then the background application/OS may close the foreground application (for example, on iOS4 platform) or the background application/OS may push one or more currently running foreground applications (for example, on an Android platform) to the background mode. Then the application may be brought to the foreground. The mobile computing device application may subsequently initiate an http (HyperText Transfer Protocol)/RTP (Realtime Transport Protocol) session with the board to download (stream) the video and may use the SIP connection for bi-directional audio communication. For sending the door lock/unlock commands, separate secured connection (SSL (Secure Sockets Layer)/TSL over IP) may be established between the application and the board 210. At the end of the session, the application may close a secured communication channel and/or video session. The SIP connection may remain active to receive subsequent notifications.

The application may be configured to run on mobile computing device platforms which do not support multi-tasking applications (e.g., iOS3/iPhone3).

On platforms which do not support multi-tasking (Background/Foreground applications) operations, a separate server based notification may be required to notify the mobile computing device application about a doorbell event. A secured communication channel may be established between 1) Service notification server (e.g., APNS (Apple Push Notification Service) server for iOS3 platforms) and a notification provider (such as a doorbell security system notification server (e.g., Holovision notification server)), 2) mobile computing device 220 (example: iOS3 phone) and a notification provider and 3) a mobile computing device 220 and an event notification server (such as APNS). When a doorbell event occurs, the board may send this event to a notification provider (e.g., Holovision notification server), wherein the notification provider and in turn may forward these notifications to the event notification server (e.g., APNS). The APNS, for example, may send the event to a registered mobile computing device 220, such as an iPhone3/iOS3 device. The event may be displayed on the mobile computing device 220.

If a user acknowledges the event, then the OS may bring up the doorbell security system application. The application may then initiate an http/RTP session with the board 210 to download (stream) the video and may use the SIP/RTP connection for bi-directional audio communication. For sending the door lock/unlock commands, separate secured connection (SSL/TSL over IP) may be established between the application and the board. At the end of session, the application may close the secured communication channel, video session, and SIP audio session.

Doorbell security system board 210 may include one or more processors. For example, the board 210 may include or be based on TI's (Texas Instrument's) DaVinci series processor. The doorbell security system board 210 may host an embedded Linux Operating System and open source Live Media Server. The processor 410 (e.g., TI's DaVinci series processor) may include a core (e.g., an ARM9 core) and a video sub processing unit configured to support video codec's such as H.264, MPEG4, and MJPEG.

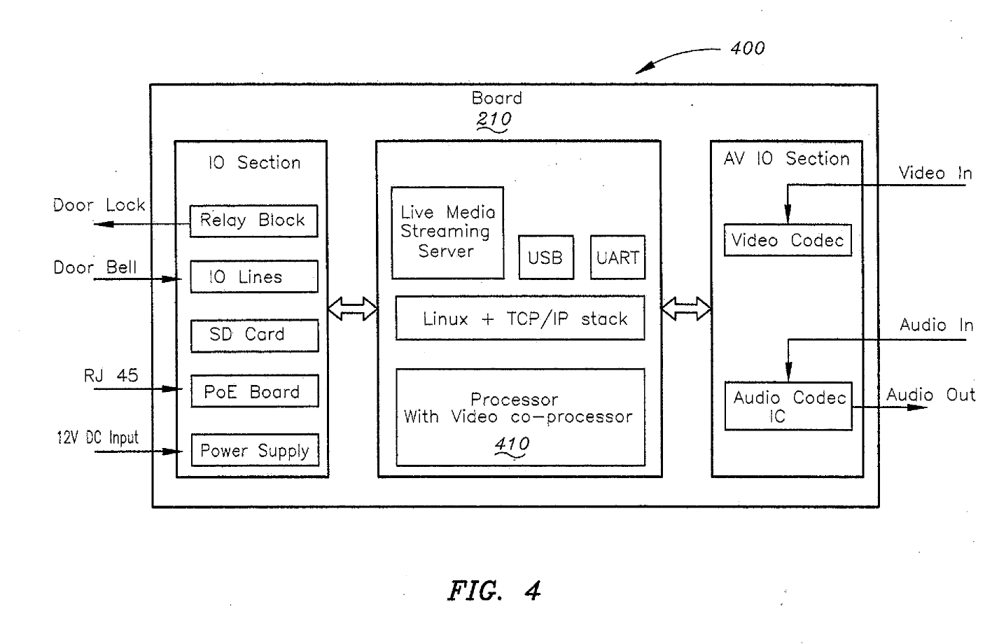

Referring to FIG. 4, a block diagram of a suitable configuration 500 of electronic components of a doorbell security system board 210 is depicted.

The processor 410 may include a video codec section. The video codec section may receive an external composite video signal (such as an NTSC/PAL (Phase Alternating Line) signal) through a connector (such as a BNC connector) and may provide the signal to the processor 410 in digital format (such as BT-656). Within the processor 410, an incoming video stream may be processed by the video processing sub unit and may be further provided to a core (e.g., an ARM core). The core (e.g., ARM) then may packetize the data, either as MJPEG images or H.264 video in RTP packets, which later may be sent through an Ethernet chip.

An audio codec section, integrated with processor through bidirectional 12S bus, may be configured for receiving audio input through a suitable interface and providing audio output to the mobile computing device 220 or the doorbell 230 through a suitable interface. Encoding and compression of audio may be performed inside the processor 410 in a suitable or required format. According to particular audio compression/encoding algorithms, sampling frequency and resolution may be adjusted in the codec IC (integrated circuit).

A door lock or door lock mechanism may be directly connected to doorbell security system board's relay output such that upon receiving a door unlock command, the relay may be energized to open the door. An isolated interface for connecting a doorbell 230 may be provided on the board.

The doorbell security system board 210 may include multiple power supply options, including a 12V (volt) DC (direct current) adapter and Power over Ethernet (PoE).

A removable storage slot (such as an SD (secure disk) memory card slot or the like) may be used to store transaction details or other data.

The doorbell security system board 210 components may include the following, suitable substitutes of the following, or functional equivalents of the following: an Rj-45 connector for 10/100 Ethernet port with PoE capability; a BNC connector for composite video; an audio input and output configured with suitable interfaces; a relay output for a door unlock mechanism; an SD memory card slot for expansion; a 12V power supply connector; and a doorbell input connector.

Contemplated embodiments of the present invention include firmware or software which may include a Live Media server which may run on an embedded Linux platform with support for MJPEG over http, H.264 over RTP/RTSP, SIP, and audio codecs. The firmware, software, or live media server may be configured for streaming H.264 over http for progressive download and may support HTTP Live streaming in a configuration supported on iOS platforms.

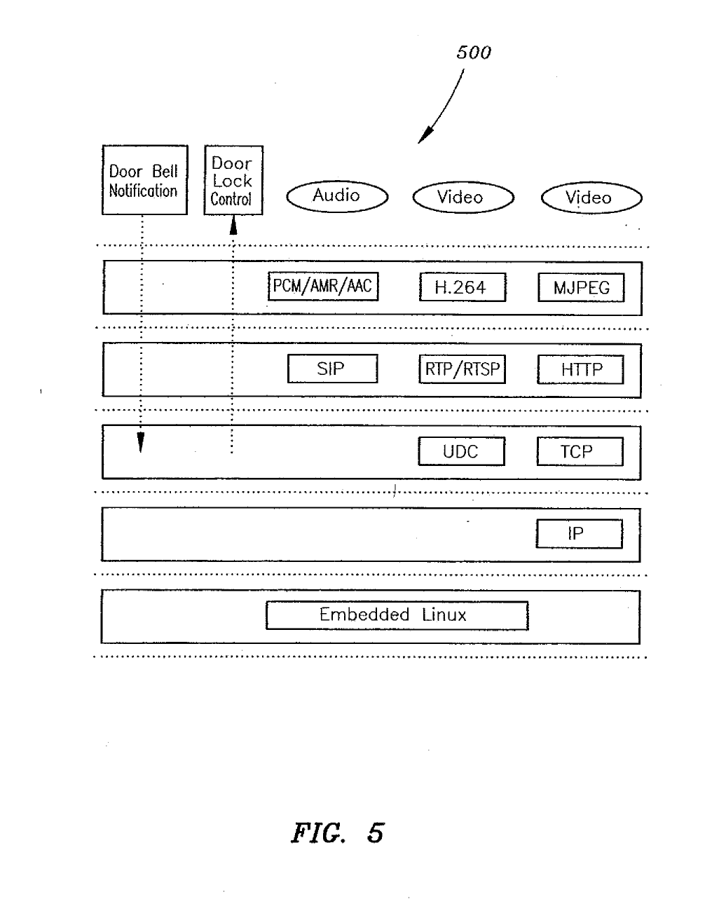

Referring to FIG. 5, a block diagram of suitable firmware architecture 500 associated with the doorbell security system 200 and a server is depicted.

The doorbell security system board 210 may include an embedded Linux kernel 2.6 as a base platform running on a core of the processor 410. For networking, the doorbell security system board 210 may use a Linux TCP (Transmission Control Protocol)/IP stack.

The Live Media server may include an open source C++ library for multimedia streaming, using protocols such as RTP/RTSP, HTTP, and SIP. Live media server may handle video and bi-directional audio streaming with a client application.

The video sub-processor may run algorithms to encode raw video into required video formats. Suitable methods of streaming video to a user may include: MJPEG over HTTP and H.264 RTP tunneling through HTTP. In some embodiments, the video sub-processor may process multiple streams of data. For example, some video encoders simultaneously stream the same video feed in two or more sessions. Using the MJPEG format over HTTP, video may be transmitted as a series of JPEG images over HTTP. In this method each frame may be compressed using the JPEG algorithm and may be sent over the Ethernet. In H.264 RTP tunneling through HTTP, raw video may be compressed in H.264 format and may be packetized using an RTP protocol and may send it over the HTTP. H.264 may use inter frame compression technology, which requires less network bandwidth for the same image quality achieved for MJPEG.

Bi-directional audio communication may be established using SIP protocol, which may be included in a live media server library. The doorbell security system firmware may support suitable audio codecs, including: 16-bit PCM (Pulse Coded Modulation), AMR (Adaptive Multi-Rate), or AAC (Advanced Audio Coding). 16-bit PCM is an uncompressed audio format which requires less processor bandwidth for playback at the user side. AMR is an audio codec optimized for speech coding, which adjusts the bit rate according to the link conditions. AAC is a default audio format for some products and gives high quality audio at similar bit rates.

An application over a secured layer over TCP/IP on the processor core (e.g., ARM core) may handle doorbell event notification and may process a user request for video stream and a door unlock message. On reception of a doorbell trigger, a client application may be notified either through the direct connection between the doorbell security system board 210 and the mobile computing device 220 or through a back-end server mechanism. Once the user accepts a notification, the doorbell security system server may begin streaming video and establish a bi-directional audio link between the board 210 and the mobile computing device. The door lock/unlock command may be passed over a secured TCP/IP link between the two.

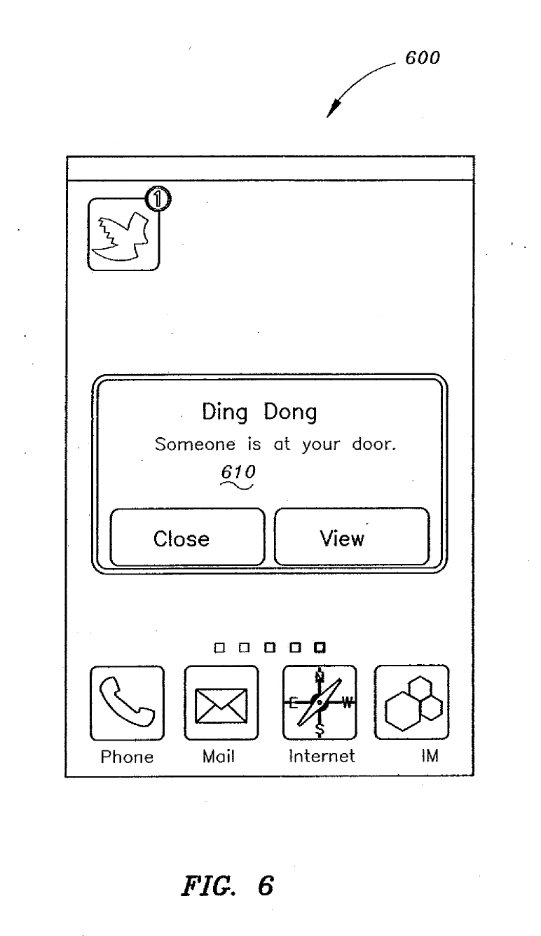

Referring specifically to FIG. 6, a diagrammatic view of a screen 600 displaying a doorbell notification 610 and a UI (user interface) (such as a GUI (graphical user interface)) on a smart phone platform is depicted.

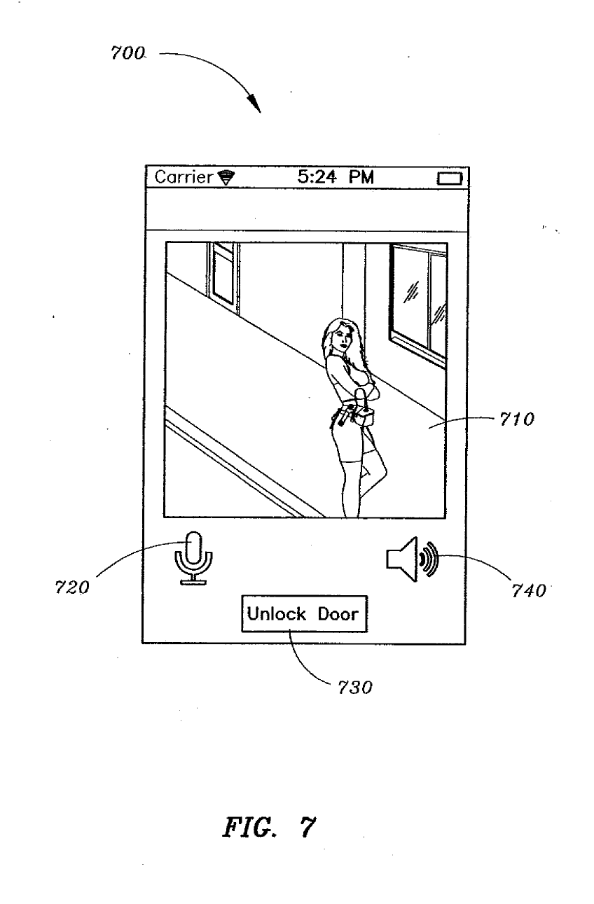

Referring to FIG. 7, a diagrammatic view of a door lock application running on a smartphone screen 700 is depicted. The application of a mobile computing device 220, such as a smart phone, may include one or more screens for a user to interact with. A screen may display information. For example, a square window may display real-time or substantially real-time video 710 from a doorbell unit camera and may be configured to occupy a majority of the screen space. For example, one or more action buttons 730 may be located below the video box which control the lock/unlock door operations. The screen may also display GUI buttons 720, 740 which can represent the microphone and the speaker and which can be configured to control the application's audio communications.

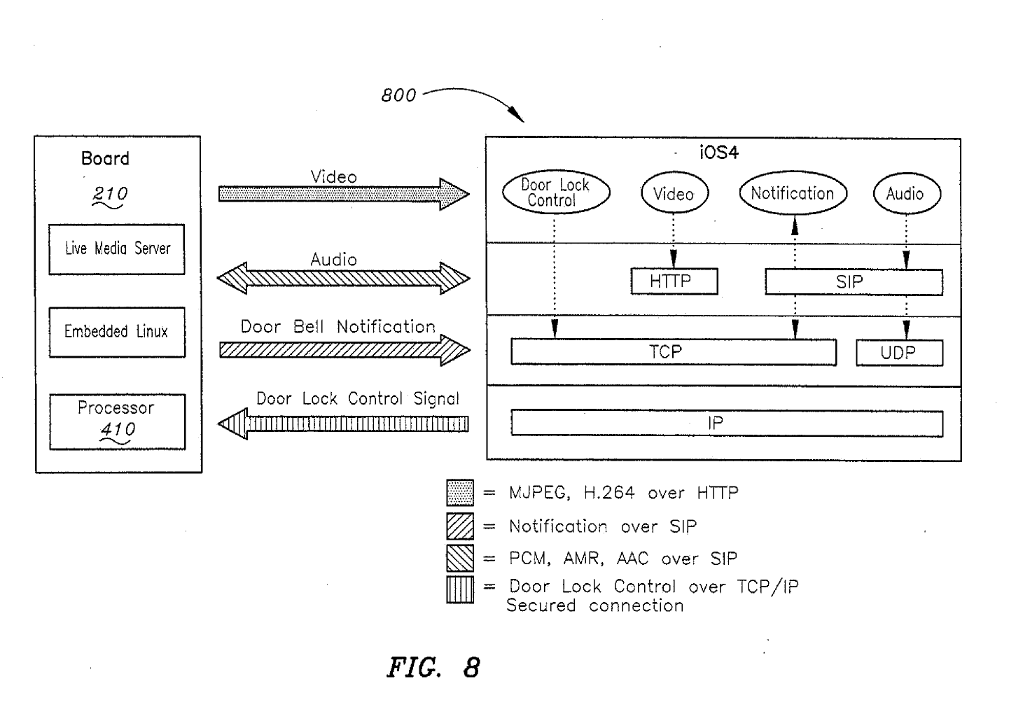

Referring to FIG. 8, a suitable software architecture 800 diagram of embodiments configured to support iOS4 is depicted. While the following is described in the context of iOS4, it will be understood that updated versions of the iOS may be configured to operate under embodiments of the subject technology. Embodiments of the present invention may include system architecture configured to support a native application on an iOS 4 mobile computing device. A doorbell press event notification may be transmitted as data over an SIP connection between the doorbell security system board 210 and a registered iOS 4 device 220. The SIP connection may be established when the registered mobile computing device 200 (installed with the application) is powered on. The video (e.g., in H.264 or MJPEG format) may be transmitted over HTTP from the board 210 to the registered iOS 4 mobile computing device 220. The audio (e.g., in 16-bit PCM, AMR or AAC formats) communication between the board 210 and the registered iOS 4 mobile computing device 200 may be established by SIP. The iOS 4 device may send a control signal or command to lock/unlock the door by transmitting data securely over TCP/IP to the board 210.

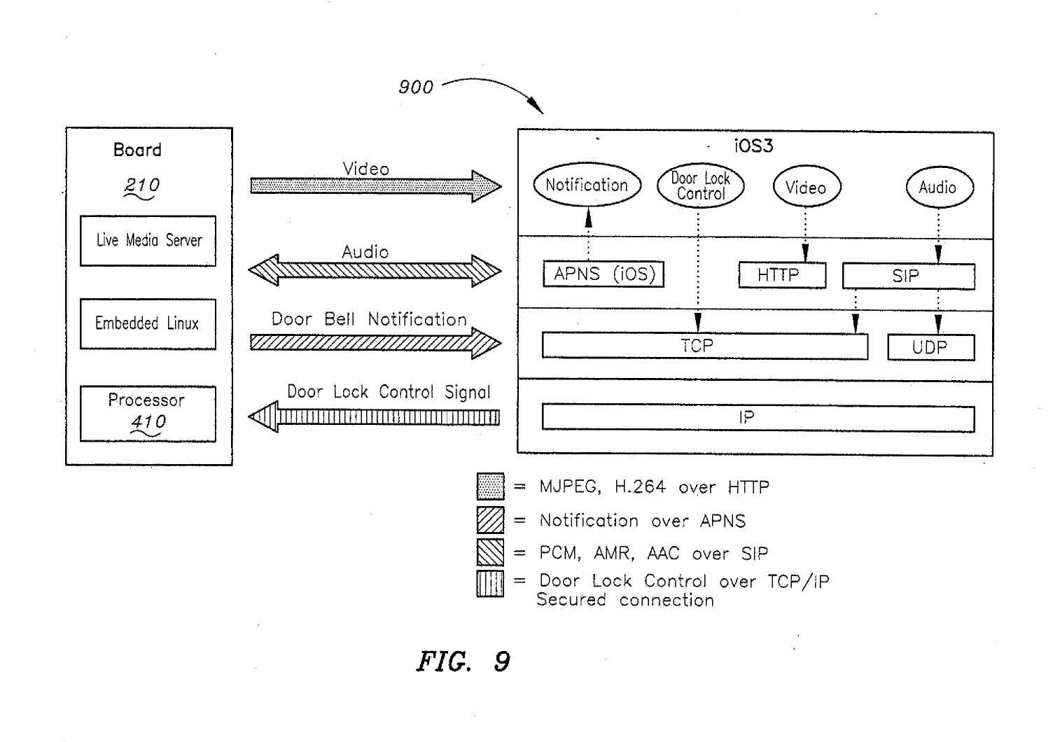

Referring to FIG. 9, a suitable software architecture 900 diagram of embodiments of the present invention configured to support iOS3 is depicted. Embodiments of the present invention may include system architecture configured to support a native application on iOS 3. While the following is described in the context of iOS3, it will be understood that updated versions of the iOS may be configured to operate under embodiments of the subject technology. The board 210 may notify the doorbell press event by sending a message directly or indirectly via notification provider (e.g., via the doorbell security system notification server or Holovision notification server) to an Apple Push Notification service (APNS) server. The APNS server, in turn, may notify an iOS 3 device 220 installed with the application. A prior connection may need to exist between the board 210 and the APNS server and also between the APNS server and the iOS 3 device 220 for this notification mechanism to function correctly. The video (in H.264 or MJPEG format) may be transmitted over HTTP from the board to the iOS 3 device 220. The audio (in 16-bit PCM, AMR or AAC formats) communication between the board 210 and the iOS 3 device 220 may be established by the Session Initiation Protocol (SIP) when the application starts up. The iOS 3 device 220 may send a control signal to lock/unlock the door by transmitting data securely over TCP/IP to the board 210.

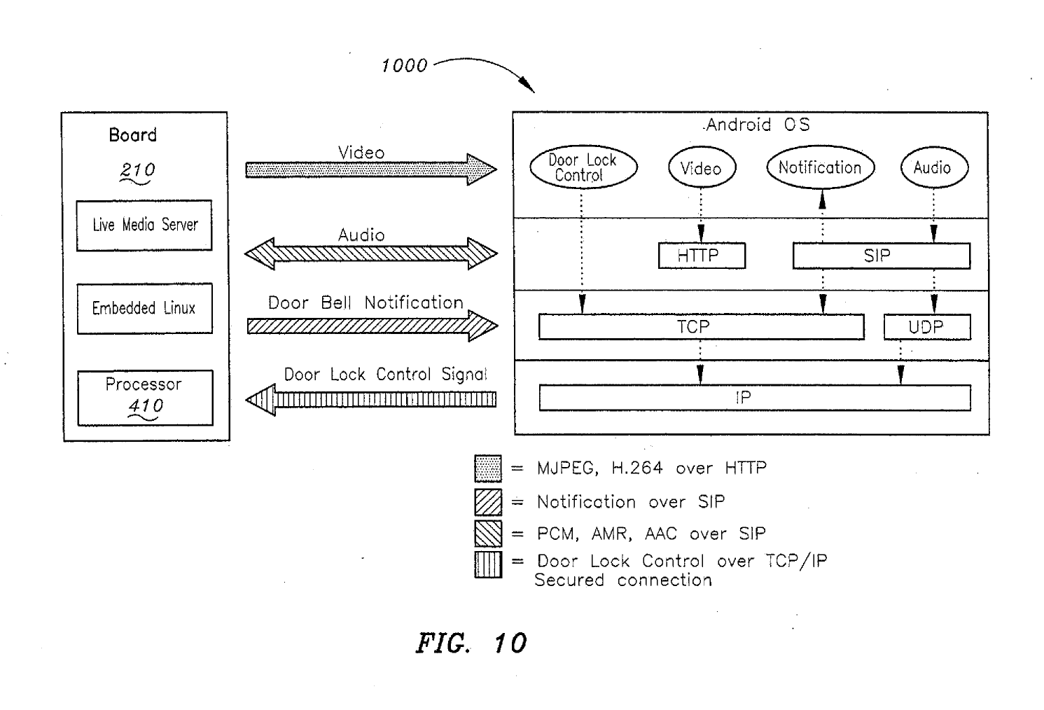

Referring to FIG. 10, a suitable software architecture 1000 diagram of an embodiment of the present invention configured to support Android is depicted. Embodiments of the present invention may include system architecture configured to support a native application on Google Android. The doorbell press event may be notified by transmitting data over the SIP connection between the board 210 and the registered Android device 220 (which may be running the application in the background). The SIP connection may be established when the Android device is powered on by starting the application and running it in the background. The video (in H.264 or MJPEG format) may be transmitted over HTTP or RTP/RTSP from the board 210 to the Android device 220. The audio (in 16-bit PCM, AMR or AAC formats) communication between the board 210 and the Android device 220 may be established by the Session Initiation Protocol (SIP). The Android device 220 may send a control signal to lock/unlock the door by transmitting data securely over TCP/IP to the board.

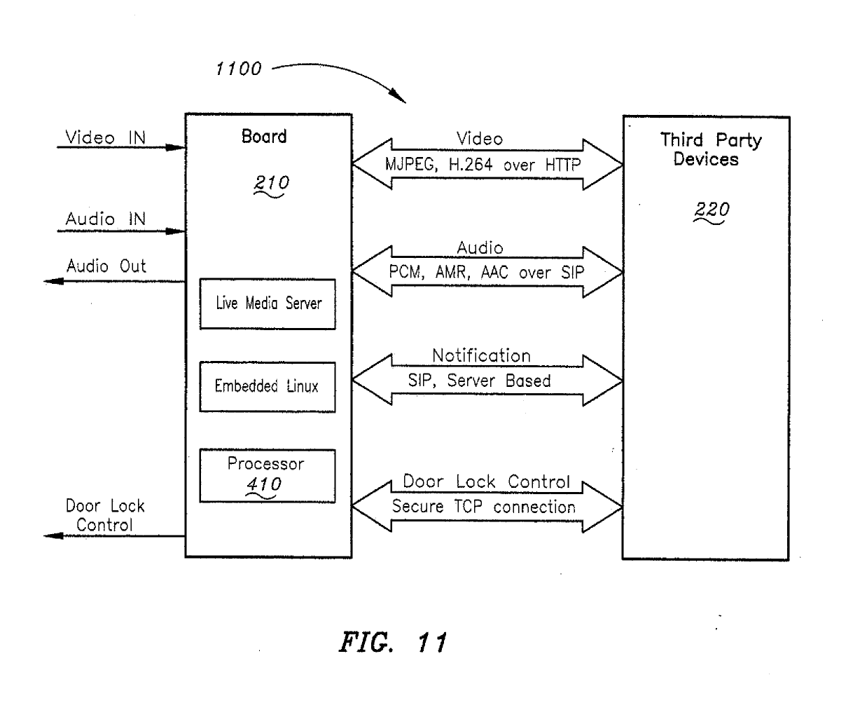

Referring to FIG. 11, a suitable software architecture 1100 diagram of embodiments of the present invention configured for supporting third party devices 220 is depicted. Embodiments of the present invention may include system architecture configured to support a native application on third party platforms. The intended system architecture to support a native application on third party platforms is depicted in FIG. 11 and is similar to the architecture depicted in FIG. 10 (and described above) for Android devices.

Embodiments of the present invention include a number of different press event notification configurations or options. When the doorbell 230 is pressed, the board 210 may attempt to notify the registered or associated mobile computing device 220 even if the mobile computing device 220 is not running. Different options or configurations can be implemented for event notifications on different platforms.

For example, iOS 4 may provide multitasking support for VOIP applications. The application may be a VOIP application requiring background run support from the operating system. When the application terminates, the operating system may take responsibility of monitoring the application's sockets tagged for VoIP communications. Whenever some data arrives on the tagged sockets, the operating system may alert the user. This capability may be used to send data when a doorbell press event occurs.

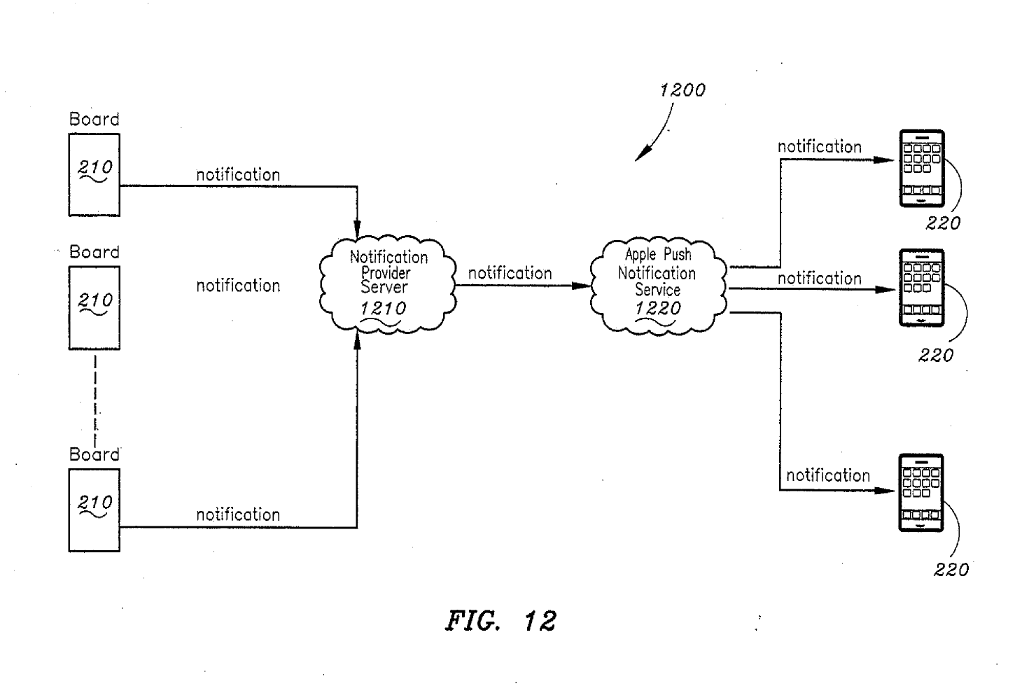

Referring to FIG. 12, a diagram of a notification system 1200 for iPhone 3 platforms is depicted. iOS 3 does not provide multitasking support. As a result, the Apple Push Notification Service (APNS) may be used. This approach may require a notification provider server (e.g., Holovision application server) that is registered as a “provider” for a specific application with Apple. The application and the mobile computing device 220 that is running application may also need to be registered with Apple. This mechanism is detailed in the FIG. 12. Single or multiple boards 210 may generate notifications when they sense the doorbell press event. These notifications may be communicated to the notification provider server (e.g., Holovision server), which in turn may notify the APNS server. The APNS may take responsibility of forwarding the notifications to the concerned mobile computing devices 220. When a device 220 receives a push notification, it may alert the user.

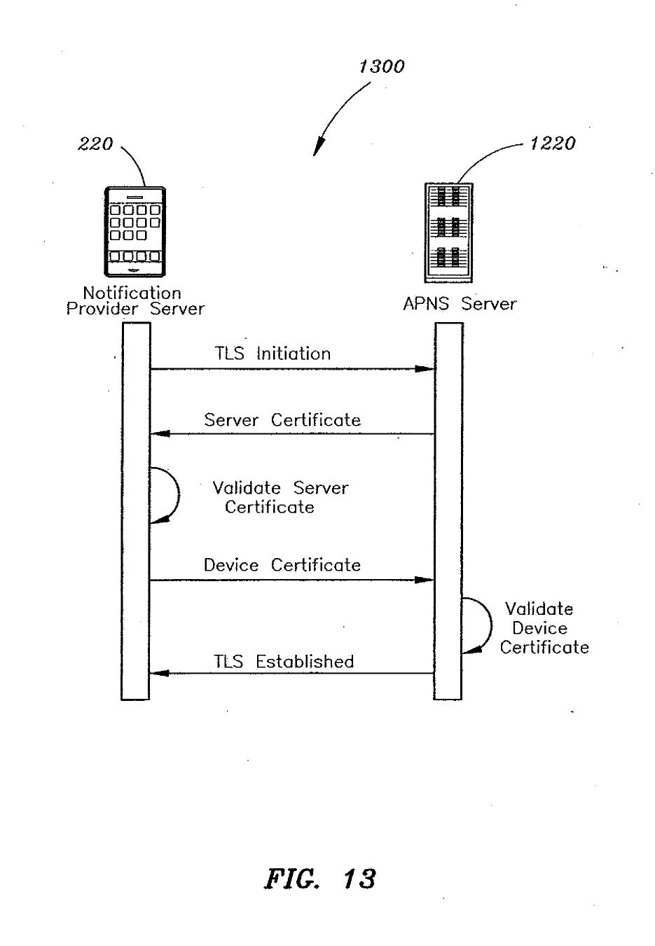

Referring to FIG. 13, a diagram of a device communicating 1300 with an APNS Server is depicted. Embodiments of the invention may implement a Device-To-Service Connection trust. When an iOS device 220 is switched on, it may initiate a TLS/SSL connection with Apple's APNS server. The server may respond with its certificate. This certificate may then be validated by the device 220 which may send back its device certificate. This certificate may be validated by the APNS server for device legitimacy and a connection may be established between the two parties.

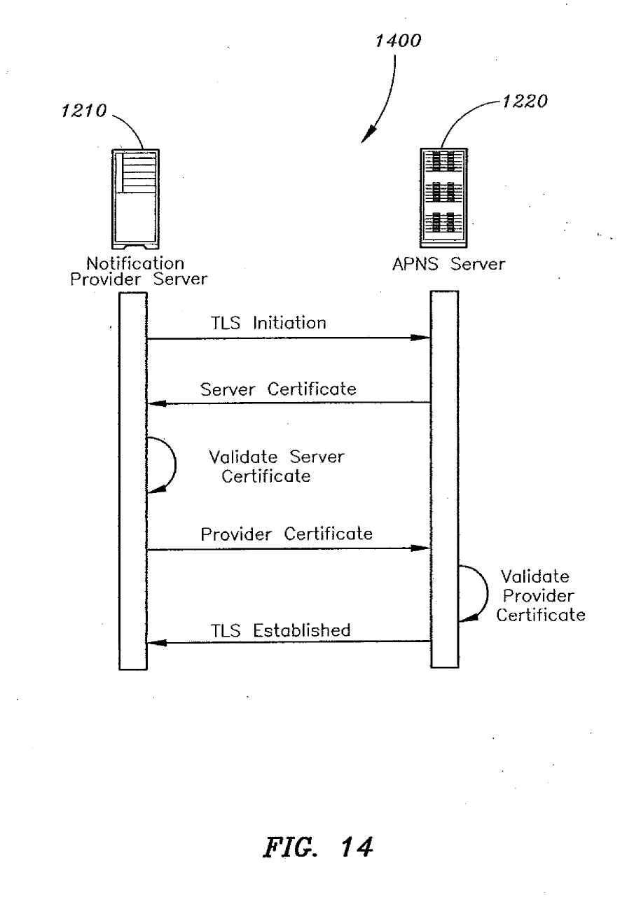

Referring to FIG. 14, a further diagram of a device communicating 1400 with an APNS server is depicted. Embodiments of the invention may implement a Provider-To-Service Connection trust. When the provider, such as notification provider server (e.g., a Holovision server), is powered on, it may initiate a TLS/SLL connection with Apple's APNS server which may respond with its server certificate. The provider may validate this certificate and may respond back with its provider certificate which may be validated by the APNS server for provider legitimacy and a persistent connection may be established.

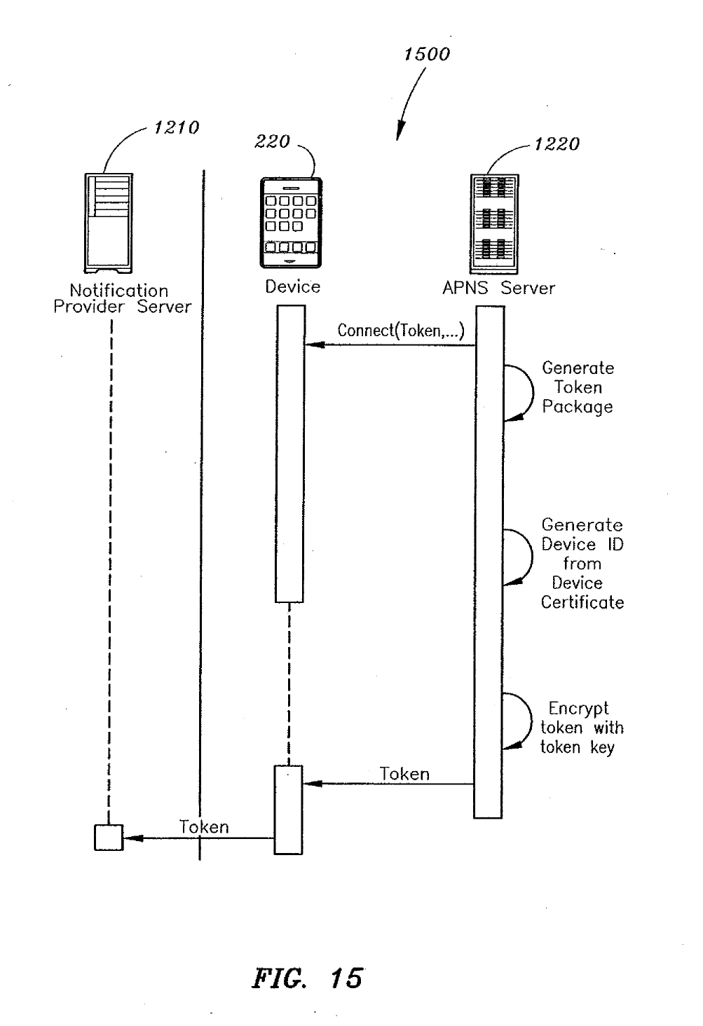

Referring to FIG. 15, a diagram of a device communicating 1500 with an APNS server is additionally depicted. Embodiments of the invention may implement a Token Generation and Dispersal. When an application is installed on an iOS device 220, it may register with the APNS server to get push notifications. It may send a registration request to the operating system which may forward it to the APNS server. The token passed may contain a device ID which is encrypted and returned to iOS by the APNS server. This token may then be passed to the application which forwards the same to the provider.

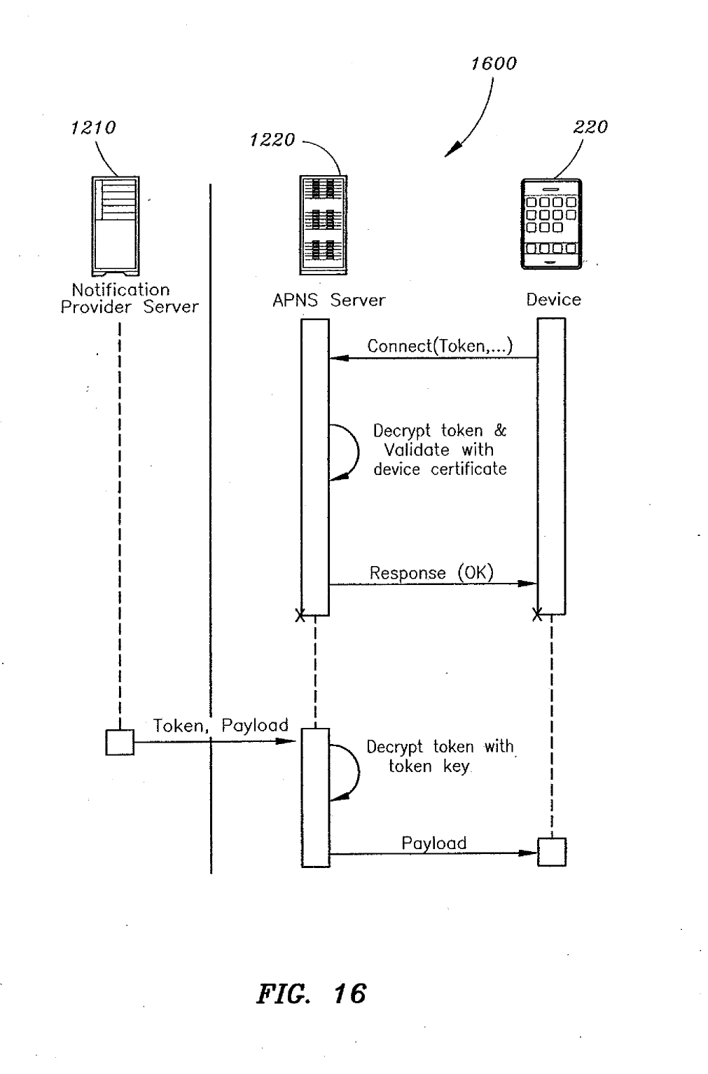

Referring to FIG. 16, a diagram of a secured token communication 1600 is depicted. Every time an iOS device 220 intends to connect with the APNS server, it may be required to provide the token received during registration. This token may be decrypted and validated with device certificate by the APNS server. Whenever the provider wants to send a push notification, the device token obtained from the application should also be sent. The APNS server may decrypt the token with the token key to establish the validity of the notification. Then, the device may be identified from the device ID in the token and the notification may be sent.

In some embodiments configured for Android devices 220, the Android platform may provide multitasking support. The application may run in the background listening on its VOIP socket. Whenever some data arrives on the VOIP socket, the operating system may alert the user. This capability may be used to send data when a doorbell press event occurs. The application may be brought to the foreground when a data packet is detected. Additionally, Google's Cloud to Device Messaging framework (C2DM) may be used.

In embodiments configured for third party devices, if a platform provides support for multitasking, the application may run in the background as described above for the Android platform. If a platform does not provide support for multitasking, the product may use a mechanism similar to Apple's Push Notification Service mechanism (if available), as described above.

Embodiments of the doorbell security system may include video transmission. The video captured by the camera of the doorbell unit 230 may be transmitted over the network. The video format used may depend on the capability of the smart phone/device to display such a video in real-time or substantially real-time. Different options are available depending on the different platforms of various mobile computing devices 220.

For iOS 4/iOS 3 mobile computing devices 220, video transmission may include MJPEG over HTTP or H.264 video content delivered by using RTP/HTTP tunneling. For MJPEG over HTTP, the video view port on the screen of the iOS 4/iOS 3 mobile computing device 220 may be a web browser control. When the application starts, an HTTP request may be sent to the board 210 which may respond with the web page containing a video frame (first in a sequence of digital video frames) compressed as a JPEG image. The sequence of JPEGs may be streamed from the board 210 over HTTP using a special mime-type which informs the browser control to expect the response in several parts. This process creates the effect of a motion picture. The connection may remain open as long as the browser control wants to receive new frames and the board wants to send new frames. For H.264 video content delivered using RTP/HTTP tunneling, a H.264 over HTTP using progressive download mechanism may be used. The progressive download mechanism may create short video files on the board storage which may progressively downloaded by the video player control in the mobile computing device application. Additionally, an H.264 over HTTP using HTTP Live streaming mechanism may be used. For the H.264 over HTTP using HTTP Live streaming mechanism, includes automatically switching to lower qualities when faced with lower bandwidths.

For Android or third party platforms video transmission may include MJPEG over HTTP or H.264 over RTP/RTSP or HTTP protocols. For MJPEG over HTTP, the video view port on the screen of the iOS 4/iOS 3 mobile computing device 220 may be a web browser control. When the application starts, an HTTP request may be sent to the board 210 which may respond with the web page containing a video frame (first in a sequence of digital video frames) compressed as a JPEG image. The sequence of JPEGs may be streamed from the board 210 over HTTP using a special mime-type which informs the browser control to expect the response in several parts. This process creates the effect of a motion picture. The connection may remain open as long as the browser control wants to receive new frames and the board wants to send new frames. For H.264 over RTP/RTSP or HTTP protocols, the video view port on the screen may be a media player control. When the application starts, the media player may start downloading and playing the video file specified by a URL that points to the location where the board is continuously creating short video files from the camera output. The files may be downloaded and played one after the other in a sequence.

Embodiments of the doorbell security system 200 may include several doorbell commands. Doorbell commands may include opening, closing, unlocking, or locking a door or the like. The doorbell commands may be transmitted over an IP Link. A separate TCP/IP session may be established to send commands from the recipient mobile computing device 220 to the board 210. This communication may be secured using SSL or other secured mechanisms to prevent unauthorized programs from issuing commands to open, close, unlock, or lock the door.

In some implementations of embodiments of the present invention, the present invention may be configured such that the doorbell notification latency may be limited to within a few seconds (e.g., 0.5 seconds, 1 second, 3 seconds, 10 seconds, or the like). Additionally, embodiments of the present invention may be configured such that the audio/video communication latency may be within a few seconds (e.g., 0.05 seconds, 0.1 seconds, 0.5 seconds, 1 second, 3 seconds, 10 seconds, or the like).

Embodiments of the present invention may be configured to send multiple outgoing connections from the board 210 to Smartphone applications. It is contemplated that one or more mobile computing devices may be paired with the board 210. For each device 220 an active SIP connection may need to be maintained for doorbell notifications for iOS4 or Android platforms.

Embodiments of the invention may be configured for multiple outgoing connections from a mobile computing device 220 to the board 210. Embodiments may be configured such that multiple doors may be controlled by one mobile computing device 220. For each connection, an active SIP connection may be maintained by iPhone/Android application. For example, board 210 to mobile computing device 220 connections may include any of the following cases: one-to-one connection between the board 210 and a mobile computing device application; many-to-one connection between the board and the mobile computing device application; one-to-many connection between the Board and mobile computing device application; and Many-to-Many connection between the board 210 and mobile computing device application.

Some embodiments of the doorbell security system 200 may be configured to be implemented with existing video door phones (such as a Holovision door phone). Other embodiments of the present invention may include modification or upgrade systems, kits, methods, or software to upgrade an existing video door phone to include features of the present invention.

In some embodiments, the doorbell security system 200 may include a mobile computing device running an SIP server. These embodiments may include communicating audio, video, and/or notifications over an SIP connection through the SIP server running on the mobile computing device. In some implementations, the SIP server may be running on a mobile computing device such as a tablet computing device (e.g., an iPad, Android tablet, or the like). The SIP server running on the mobile computing device may be configured to maintain one or more SIP connections between a mobile computing device 220 and the doorbell security system board 210. For example, the SIP server mobile computing device may be located within a household equipped with the doorbell security system 200. In other implementations, the SIP server mobile computing device may be located remotely from a location of the doorbell security system. Running the SIP server on a mobile computing device can provide heightened security for the doorbell security system 200 and increased control over data connections of the doorbell security system 200. When a visitor presses the doorbell, a notification signal may be sent from the doorbell 230 to the board 210 of the doorbell security system 200. The board 210 may then send an event notification to the SIP server running on the mobile computing device, and the SIP server running on the mobile computing device may relay the notification to another mobile computing device 220 where a user can respond to the notification. Additionally, audio and/or video may be communicated between the board 210 and the other mobile computing device 220 via the SIP connection through the SIP server of the mobile computing device.

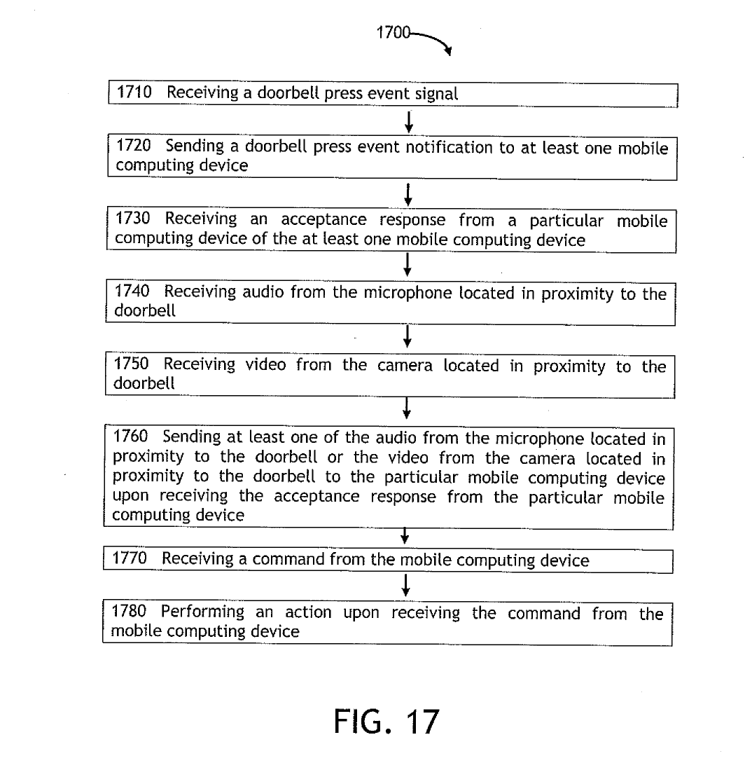

Referring to FIG. 17, an embodied method 1700 for operating a doorbell security system 200 is depicted. It is contemplated that embodiments of the method 1700 may be performed by one or more controllers, one or more processors, software, firmware executed on a computing device (such as a processor) of the doorbell security system board 210, other computing devices, other computer components, or on other software, firmware, or middleware. The method 1700 may include any or all of steps 1710, 1720, 1730, 1740, 1750, 1760, 1770, or 1780, and it is contemplated that the method 1700 may include additional steps as disclosed throughout, but not explicitly set forth in this paragraph. Further, it is fully contemplated that the steps of method 1700 may be performed concurrently or in a non-sequential order.

The method 1700 may include a step 1710, wherein the step 1710 may include receiving a doorbell press event signal. The method 1700 may include a step 1720, wherein the step 1720 may include sending a doorbell press event notification to at least one mobile computing device. The method 1700 may include a step 1730, wherein the step 1730 may include receiving an acceptance response from a particular mobile computing device of the at least one mobile computing device. The method 1700 may include a step 1740, wherein the step 1740 may include receiving audio from the microphone located in proximity to the doorbell. The method 1700 may include a step 1750, wherein the step 1750 may include receiving video from the camera located in proximity to the doorbell. The method 1700 may include a step 1760, wherein the step 1760 may include sending at least one of the audio from the microphone located in proximity to the doorbell or the video from the camera located in proximity to the doorbell to the particular mobile computing device upon receiving the acceptance response from the particular mobile computing device. The method 1700 may include a step 1770, wherein the step 1770 may include receiving a command from the mobile computing device. The method 1700 may include a step 1780, wherein the step 1780 may include performing an action upon receiving the command from the mobile computing device.

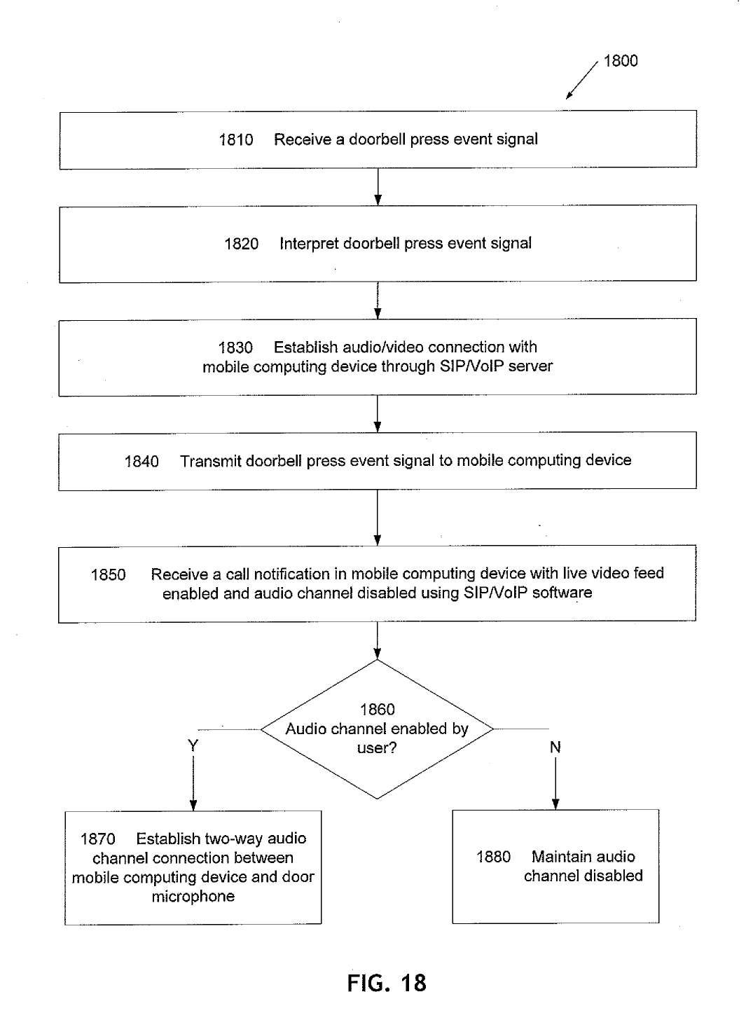

Referring to FIG. 18, a method 1800 for operating a doorbell security system is shown. The method 1800 may be used for example with the doorbell security system 200, however it will be understood that other doorbell security systems may operate via the method 1800. It is contemplated that aspects of the method 1800 may be performed by one or more controllers, one or more processors, software, firmware, other computing devices, other computer components, or middleware. The method 1800 may include any or all of the described steps and it is contemplated that the method 1800 may include additional steps as disclosed throughout, but not explicitly set forth in the following description. Further, it is fully contemplated that the steps of method 1800 may be performed concurrently or in a non-sequential order.

The method 1800 may include a step 1810 of receiving a doorbell press event signal. Receipt may occur for example, at a processor in the doorbell security system, an intermediate server between the doorbell security system and a mobile computing device of the client user (for example, the mobile computing device 220), and/or at the mobile computing device. The doorbell press event may signal that a person is at a doorway equipped with the doorbell security system and the person may wish to gain access or communicate with the client user.

In step 1820 the doorbell press event signal may be interpreted and translated from a doorbell signal to a digital signal indicating activation of the doorbell that should be passed on to the mobile computing device. For example, the mobile computing device may provide the client user a displayed alert, audio alert, and/or vibration alert indicating that the doorbell has been pressed.

In step 1830, an audio and video connection may be established simultaneously, via the SIP or VoIP server, between the doorbell security system and the mobile computing device in response to the doorbell signal event being triggered. In some embodiments, the audio/video connection maybe established using a SIP session description protocol (SDP) payload to deliver the URL of the RTSP stream of the camera or video feed. In other embodiments, the SIP or VoIP server may establish the audio/video connection by using a module/script/plug-in of a native or a third party source to initiate a 3-way SIP or VoIP call between the IP address of the video camera feed, the client software application on the mobile computing device, and a doorbell intercom of the doorbell security system. In other embodiments, the SIP or VoIP server may establish the audio/video connection by placing a SIP or VoIP call to an external media server interface, the doorbell intercom and the mobile computing device SIP/VoIP software application. In other embodiments, the SIP or VoIP server may establish the audio/video connection by conferencing the doorbell security system video camera, which has SIP client capabilities, a mobile computing device SIP/VoIP software application, and the IP address of the intercom using a SIP conference session. It may be appreciated that the features described in step 1840 allows client users to connect from anywhere to their doorbell security system and be alerted to visitors, solicitors, or the like. Instead of, for example, a closed circuit surveillance system that requires the client user to be physically on-site or a surveillance system that is separate from the doorbell system and does not notify the client user of visitors, the client user may, by using embodiments of the subject technology, access the doorbell security system from anywhere knowing someone is at the door. In addition, embodiments alert the client user who may be far from his or her door and out of earshot of the doorbell in the home bringing to the user's attention that someone has arrived.

In step 1840, the doorbell press event signal may be transmitted from the doorbell security system to a mobile computing device via a SIP or VoIP connection. The doorbell press event signal may be received by for example, a third party device or platform with SIP or VoIP services (for example, as described with respect to FIG. 2) before being received by the mobile computing device. This may be a SIP or VoIP server transmitting signals using for example, the H.323 protocol between the doorbell security system and a mobile computing device, however it will be understood that other telecommunication protocols may be used.

In step 1850, a call notification may be received in the mobile computing device with a live video feed from the doorbell security system enabled and an audio channel of the doorbell security system opened. The audio connection may be opened but disabled so that no audio data is provided while the live video feed is visible to the client user. In some embodiments, the audio connection may be enabled as a one-way transmission by the end client user allowing the end client-user to hear any audio from the visitor at the door but not allowing the visitor at the door to hear the end client user. It may be appreciated, that this step allows the client user to screen individuals at the doorbell security system without the individuals knowing whether or not the client user is home. In addition, this feature allows the client user to be remote from the location (for example, away from home or just far from the door) while safely determining whether the individual at the doorbell is someone who needs to be spoken to. The individual(s) at the door are unaware of whether the client user is home or in some distant locale. In some instances, the individual(s) at the door may be menacing and the client user may take appropriate action. This may be beneficial for example, when the client user is at work or on vacation and the visitor may be for example, a burglar who is merely checking to see if someone is home before breaking and entering. In instances where the client user is home, the client user can immediately notify police of the potential danger without ever approaching the door.

In step 1860, a determination may be made whether the user of the mobile computing device enables the audio channel of the doorbell security system. In response to the user enabling the audio channel, in step 1870 a two-way audio channel connection between the mobile computing device and an intercom of the doorbell security system may be established. The user may engage in communicating with the visitor until desired. It will be understood that features discussed above with reference to previous figures may be utilized, for example, the automated door locking/unlocking feature. In step 1880, the audio channel may be maintained disabled in response to the user rejecting communication with the person at the doorbell security system. The user may terminate the connection with the mobile computing device when desired.

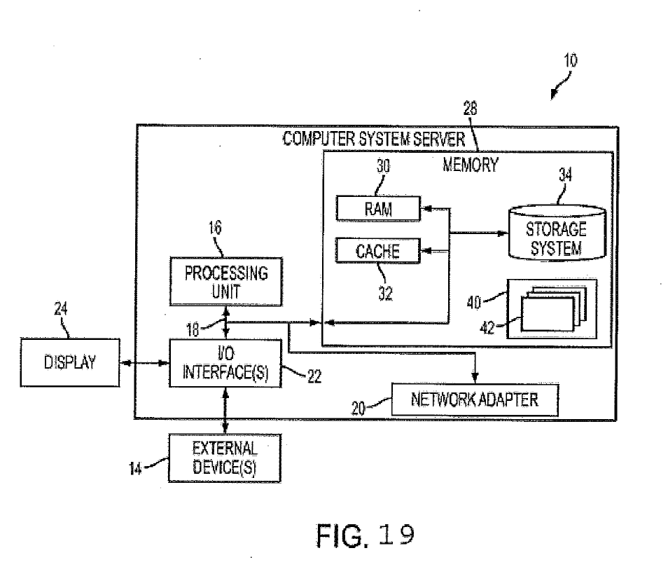

Referring now to FIG. 19, a schematic of an example of a computer system/server 10 is shown. The computer system/server 10 is shown in the form of a general-purpose computing device. The mobile computing device and/or the control box 110 (FIG. 1) and/or the third party SIP or VoIP servers may function to aspects of the computer system/server 10. The components of the computer system/server 10 may include, but are not limited to, one or more processors or processing units 16, a system memory 28, and a bus 18 that couples various system components including the system memory 28 to the processor 16. The processor 16 may be for example, the processor 410 (FIG. 8). In some instances, the processor 16 may be embedded in the mobile computing device described above throughout.

In some embodiments, the computer system/server 10 may be a cloud computing node connected to a cloud computing network (not shown). The computer system/server 10 may be for example, personal computer systems, tablet devices, mobile telephone devices, server computer systems, handheld or laptop devices, multiprocessor systems, microprocessor-based systems, set top boxes, programmable consumer electronics, network PCs, and distributed cloud computing environments that include any of the above systems or devices, and the like. The computer system/server 10 may be described in the general context of computer system executable instructions, such as program modules, being executed by a computer system (described for example, below). The computer system/server 10 may be practiced in distributed cloud computing environments where tasks are performed by remote processing devices that are linked through a communications network. In a distributed cloud computing environment, program modules may be located in both local and remote computer system storage media including memory storage devices.

The computer system/server 10 may typically include a variety of computer system readable media. Such media could be chosen from any available media that is accessible by the computer system/server 10, including non-transitory, volatile and non-volatile media, removable and non-removable media. The system memory 28 could include one or more computer system readable media in the form of volatile memory, such as a random access memory (RAM) 30 and/or a cache memory 32. By way of example only, a storage system 34 can be provided for reading from and writing to a non-removable, non-volatile magnetic media device typically called a “hard drive” (not shown). The system memory 28 may include at least one program product 40 having a set (e.g., at least one) of program modules 42 that are configured to carry out the functions of embodiments of the invention. The program product/utility 40, having a set (at least one) of program modules 42, may be stored in the system memory 28 by way of example, and not limitation, as well as an operating system, one or more application programs, other program modules, and program data. Each of the operating system, one or more application programs, other program modules, and program data or some combination thereof, may include an implementation of a networking environment. The program modules 42 generally carry out the functions and/or methodologies of embodiments of the invention as described herein.

The computer system/server 10 may also communicate with one or more external devices 14 such as a keyboard, a pointing device, a display 24, etc.; and/or any devices (e.g., network card, modem, etc.) that enable the computer system/server 10 to communicate with one or more other computing devices. Such communication can occur via Input/Output (I/O) interfaces 22. Alternatively, the computer system/server 10 can communicate with one or more networks such as a local area network (LAN), a general wide area network (WAN), and/or a public network (e.g., the Internet) via a network adapter 20. As depicted, the network adapter 20 may communicate with the other components of the computer system/server 10 via the bus 18.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon. Where embodiments disclose a particular version of operating software, it will be understood that the embodiments disclosed may operate via updated versions of the software.

Any combination of one or more computer readable media (for example, storage system 34) may be utilized. In the context of this disclosure, a computer readable storage medium may be any tangible or non-transitory medium that can contain, or store a program (for example, the program product 40) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 16 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

It is believed that the present invention and many of its attendant advantages will be understood by the foregoing description, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A doorbell security system for providing a client user surveillance and communication with a visitor at a door, comprising:
a doorbell configured to provide a triggered doorbell signal event;
a video camera coupled to the doorbell and configured to capture video of the visitor at the door, wherein the video camera establishes a live video feed transmitted to a mobile computing device via a session initiation protocol (SIP) or voice over internet protocol (VoIP) connection in response to the doorbell signal event being triggered; and
an intercom coupled to the doorbell, the intercom configured to maintain an audio channel disabled during the live video feed until the client user activates the audio channel for communication with the visitor.

2. The doorbell security system of claim 1, wherein the audio channel uses the SIP or VoIP connection.

3. The doorbell security system of claim 1, wherein the audio channel is opened simultaneously with the live video feed.

4. The doorbell security system of claim 1, wherein the audio channel is controllable by the mobile computing device.

5. The doorbell security system of claim 1, wherein the audio channel is enabled by a user of the mobile computing device in response to viewing the visitor at the door via the live video feed.

6. The doorbell security system of claim 1, further comprising a control box coupled to the doorbell configured to provide a call notification alert transmitted to the mobile computing device in response to the triggered doorbell signal event.

7. The doorbell security system of claim 6, wherein the control box establishes a one-way audio channel upon a client user request.

8. A computer program product on a mobile computing device for alerting an end client user of a visitor at a door and providing an option to communicate with the visitor, the computer program product comprising a non-transitory computer readable storage medium having computer readable program code embodied therewith, the computer readable program code being configured to:
receive a triggered doorbell signal event signal;
open a live video feed of the visitor at the door transmitted to the mobile computing device via a session initiation protocol (SIP) or voice over internet protocol (VoIP) connection in response to the doorbell signal event being triggered; and
open a disabled audio channel of an intercom at the door, with the mobile computing device via the SIP or VoIP connection in response to the doorbell signal event being triggered.

9. The computer program product of claim 8, further comprising computer readable program code being configured to send an alert notification to the mobile computing device in response to the triggered doorbell event signal notifying the client end user of the visitor being at the door.

10. The computer program product of claim 8, wherein the live video feed and the audio channel are opened simultaneously.

11. The computer program product of claim 8, wherein the live video feed and the audio channel are opened using a SIP session description protocol (SDP) payload to deliver a uniform resource locator (URL) of a real-time streaming protocol (RTSP) stream of the live video feed.

12. The computer program product of claim 8, wherein the live video feed and the audio channel are opened using a module/script/plug-in of a native or a third party source to initiate a 3-way SIP or VoIP call between an IP address of a video camera providing the live video feed, the mobile computing device, and a doorbell intercom.

13. The computer program product of claim 8, wherein the live video feed and the audio channel are opened by placing a SIP or VoIP call to an external media server interface, a doorbell intercom and the mobile computing device.

14. The computer program product of claim 8, wherein the live video feed and the audio channel are opened by conferencing a video camera at the door, the video camera including SIP client capabilities, the mobile computing device, and an IP address of an intercom at the door using a SIP conference session.

15. The computer program product of claim 8, wherein the audio channel is enabled as a one-way transmission by the end client user allowing the end client-user to hear any audio from the visitor at the door but not allowing the visitor at the door to hear the end client user.

16. The computer program product of claim 8, further comprising computer readable program code being configured to determine whether the end client user of the mobile computing device enables the audio channel and in response to the user enabling the audio channel, establishing a two-way audio channel connection between the mobile computing device and an intercom communicatively connected to the mobile computing device.
